(19) United States
(12) Patent Application Publication
(10) Pub. No.: US 2026/0060177 A1
(43) Pub. Date: Mar. 5, 2026

(54) FIELD OPENING AND BREAKTHROUGH PASS GENERATION AND CONTROL

(71) Applicant: Deere & Company, Moline, IL (US)

(72) Inventors: Scott N. CLARK, Bettendorf, IA (US); Federico PARDINA-MALBRAN, Fort Collins, CO (US); Alex A. BRIMEYER, Bettendorf, IA (US); Troy M. HEIMS, Davenport, IA (US)

(21) Appl. No.: 18/816,574

(22) Filed: Aug. 27, 2024

(51) Int. Cl. A01D 41/127

(52) U.S. Cl. CPC A01D 41/1275; A01D 41/1271

(57) ABSTRACT

An estimation and control system generates a metric indicative of whether a combine harvester can perform a headland pass to open a field, without needing to be unloaded. If the metric indicated that the combine harvester will likely need to be unloaded, the estimation and control system determines whether the field can be partitioned into smaller tracts so that the combine harvester can perform a breakthrough pass on a smaller tract without needing to be unloaded. A control signal is generated based upon whether the combine harvester can perform a pass without needing to be unloaded.

### FIELD OF THE DESCRIPTION

The present description relates to agricultural equipment. More specifically, the present description relates to estimating a field opening or breakthrough pass and machine control.

### BACKGROUND

There are many different types of agricultural machines. Some such agricultural machines include agricultural harvesters. Such agricultural harvesters may include such things as combine harvesters.

During operation, a combine harvester moves through a field engaging crop. The engaged crop is processed by the combine harvester and clean crop may be stored in a clean grain tank in the combine harvester. When the clean grain tank is full, or at another desired time, the crop in the clean grain tank is unloaded from the combine harvester and transferred to a material transfer vehicle, such as a grain cart that is positioned alongside the agricultural harvester.

The discussion above is merely provided for general background information and is not intended to be used as an aid in determining the scope of the claimed subject matter.

### SUMMARY

An estimation and control system generates a metric indicative of whether a combine harvester can perform a headland pass to open a field, without needing to be unloaded. If the metric indicates that the combine harvester will likely need to be unloaded, the estimation and control system determines whether the field can be partitioned into smaller tracts so that the combine harvester can perform a breakthrough pass (a pass through a field where adjacent passes have not yet been harvested) on a smaller tract without needing to be unloaded. A control signal is generated based upon whether the combine harvester can perform a pass without needing to be unloaded.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 shows one example of a combine harvester opening a field by traversing a boundary of the entire field.

FIG. 2 is a pictorial illustration showing one example of a harvester performing a breakthrough pass on a smaller tract of land, that is smaller than the entire field.

FIG. 3 is a pictorial illustration showing a combine harvester on an irregularly shaped field.

FIG. 4 is a pictorial illustration showing a plurality of different guidance lines defining passes through a field, a plurality of different regions having different yield estimates, and a subset of the guidance lines showing passes that can be performed without a combine harvester needing to unload.

FIG. 5 is a block diagram showing one example of a field opening and breakthrough estimation and control system.

FIG. 6 is a flow diagram illustrating one example of the operation of the system illustrated in FIG. 5 in estimating whether a combine harvester can perform a headland lass and in controlling the combine harvester.

FIG. 7 is a flow diagram showing one example of the operation of the system illustrated in FIG. 5 in identifying a breakthrough pass and in controlling the combine harvester.

FIG. 8 shows one example of the system illustrated in FIG. 5, deployed in a remote server environment.

FIGS. 9, 10, and 11 show examples of mobile devices that can be used in the systems and machines shown in other figures.

FIG. 12 is a block diagram illustrating one example of a computing environment that can be used in the systems and machines illustrated in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

When an agricultural harvester is opening a field, it can be difficult to decide how to open the field (such as by harvesting the headlands and/or performing a breakthrough pass) in a way that promotes efficiency of operation for both the combine harvester and the material transfer vehicle (e.g., a tractor-pulled grain cart). For instance, during a field opening pass (or headland pass) the combine harvester may not have a sufficiently large clean grain tank such that the combine harvester can make an entire field opening pass prior to unloading. Therefore, the combine harvester needs to be unloaded at some point during the field opening pass. However, during the field opening pass or headland lass, there is often not enough room adjacent the combine harvester for the material transfer vehicle to come into position alongside the combine harvester so that the combine harvester can unload material and continue the field opening pass or headland pass. This means that the material transfer vehicle must follow the combine harvester through the field opening pass or headland pass until the harvester is nearly full. The harvester may then need to perform inefficient maneuvers to harvest enough crop adjacent the combine harvester so that the material transfer vehicle can pull next to the combine harvester into a position where it can be loaded by the combine harvester. This is not only inefficient from a time and fuel standpoint, but it increases the soil compaction in that the material transfer vehicle must also travel along with the combine harvester through the field opening pass or headland pass.

However, there may be a subsection of the field (or smaller tract of land) that can be circumvented by the combine harvester, in order to open the field, without having to unload. In such a scenario, the material transfer vehicle can simply wait in one spot while the combine harvester circumvents that smaller tract of land and then returns to the material transfer vehicle to perform an unloading operation.

The same is true when performing a breakthrough pass. For instance, when the headlands have been harvested, and the combine harvester is to perform a breakthrough pass, there may be certain high yield areas of the field where the combine harvester cannot perform the entire breakthrough pass without needing to unload harvested material into a material transfer vehicle. However, there may be other areas of the field, that are lower yield, where the combine harvester could perform a breakthrough pass without needing to unload harvested material.

The present discussion thus proceeds with respect to a system that accesses machine information, field information, and crop information to determine whether a combine harvester can perform a particular headland pass or breakthrough pass without needing to unload. In doing so, the present system estimates, or obtains an estimate of, yield in the field based upon a yield map, data layer from a prior job (spraying, scouting), sensor, vegetative index (NDVI), or other input, and also considers the remaining capacity in the clean grain tank of the combine harvester as well as other information (header width, harvest width, grain loss, etc), such as the length of the headland pass or breakthrough pass, the terrain in the field, among other things. If the combine harvester is unlikely to be able to perform the headland pass or breakthrough pass without needing to be unloaded, the system analyzes other potential passes (e.g., other headland passes or field opening passes or breakthrough passes) to suggest where the combine harvester may be able to complete the pass without needing to unload. If such a pass is identified as a candidate pass by the present system, a control signal is generated based upon the identified candidate pass.

In one example, the control signal controls an operator interface system to suggest the candidate pass to the operator. In another example, the control signal controls a navigation system or path planning system to generate a navigation route that follows the candidate pass. In another example, the control signal controls a communication system to communicate with a material transfer vehicle indicating whether the material transfer vehicle should follow the combine harvester or move to another position or wait in place for the combine harvester to return.

The system of the present description may be an algorithm or model trained to estimate whether the combine harvester can perform a particular pass without needing to unload. The algorithm or model may be a neural network, a machine learning model, a rules-based model, or another classifier or system that receives a set of inputs (such as field attributes, machine attributes, crop attributes, etc.) as well as the geographic location of a pass under analysis, and generates an output indicating whether the pass under analysis can be traversed by the agricultural harvester without the agricultural harvester needing to unload. This is just one example and other models or algorithms can be used as well.

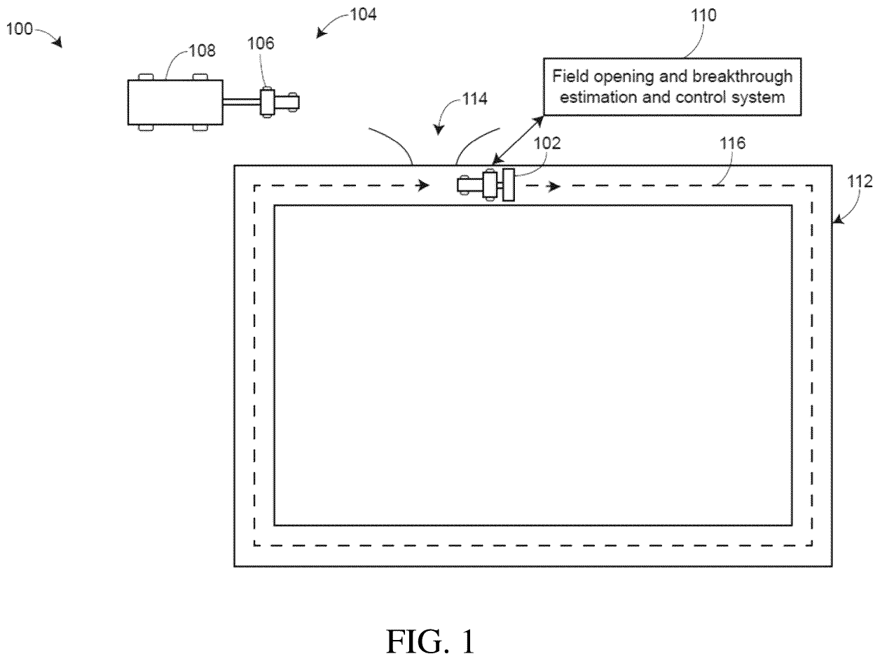

FIG. 1 is a pictorial illustration of an agricultural system 100 which includes an agricultural machine such as an agricultural harvester 102 (or combine harvester 102) and a material transfer vehicle 104 (which includes a tractor 106 pulling a grain cart 108). FIG. 1 also shows that agricultural harvester 102 has, or has access to, field opening and breakthrough estimation and control system 110. Further, FIG. 1 shows that agricultural harvester 102 is operating in a field 112 that has an approach 114 where vehicles can gain access to field 112. In the example shown in FIG. 1, agricultural harvester 102 is illustrated as operating to circumvent field 112 along a headland pass or field opening pass illustrated by the dashed arrows 116 shown in FIG. 1.

Based on the characteristics of agricultural harvester 102 (such as the width of the header of agricultural harvester 102, the size of the clean grain tank on agricultural harvester 102, among other things), and based upon the characteristics of the field 112, and crop planted in field 112 (such as the length of the field opening or headland pass 116, the estimated yield along pass 116, crop planting orientation, etc.) it may be that agricultural harvester 102 cannot fully circumvent field 112 along pass 116 without unloading harvested material from its clean grain tank into material transfer vehicle 104. In such a case, then, material transfer vehicle 104 would need to follow agricultural harvester 102 along pass 116. It may be very difficult for the operator of agricultural harvester 102 to know whether agricultural harvester 102 will be able to circumvent field 112 along pass 116 without unloading. This may result in errors or inefficiencies. For example, the operator of agricultural harvester 102 may erroneously estimate that agricultural harvester 102 will need to be unloaded and instruct material transfer vehicle 104 to follow along pass 116 when it is unnecessary (resulting in extra fuel usage, extra ground compaction, etc.). In another example, the operator of agricultural harvester 102 may erroneously estimate that unloading will not be necessary and instruct material transfer vehicle 104 to wait for agricultural harvester 102 to circumvent field 112, only to find that agricultural harvester 102 must stop when the clean grain tank is full and wait for material transfer vehicle 104 to proceed to agricultural harvester 102 for unloading.

Therefore, in accordance with one example, field opening and breakthrough estimation and control system 110 obtains characteristics or attributes of agricultural harvester 102, of field 112, and of the crop planted in field 112, and generates an output indicating whether agricultural harvester 102 likely to be able to follow pass 116 around field 112 before needing to unload harvested material. A control signal is generated based on the output from system 110 to control agricultural harvester 102. Some examples of control signals are discussed elsewhere herein.

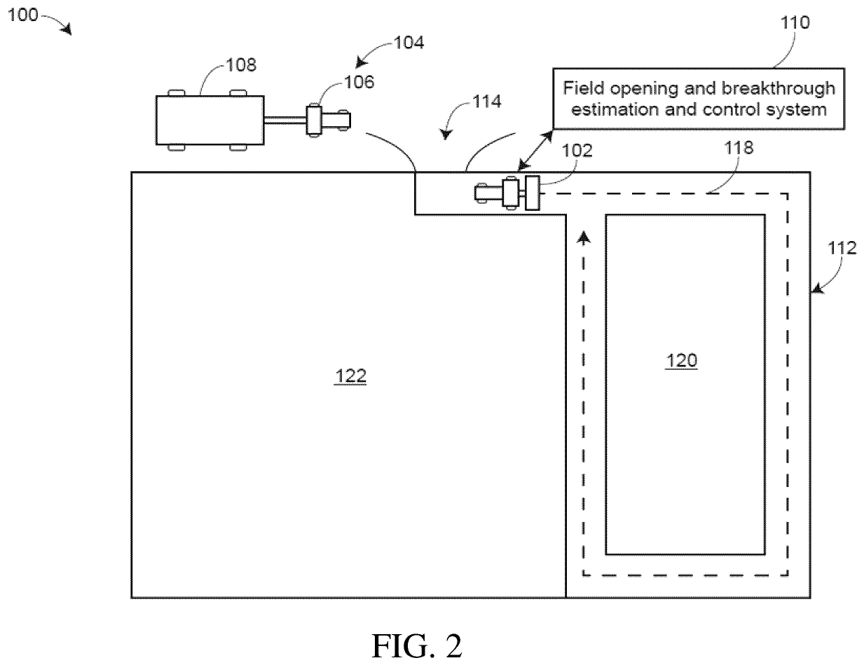

FIG. 2 shows an example in which, if it is determined that agricultural harvester 102 cannot circumvent field 112 along pass 116 without unloading, then system 110 determines whether agricultural harvester 102 can perform a breakthrough pass along route 118 by circumventing a smaller tract of land 120 of field 112, leaving a larger tract of land 122 for later harvesting. System 110 can access information to identify any remaining capacity in the clean grain tank in agricultural harvester 102, the estimated yield along other possible passes through field 112, such as along pass 118, the size of the header of agricultural harvester 102, etc., to determine whether agricultural harvester 102 can perform pass 118 around smaller tract of land 120 without needing to unload. If so system 110 can use pass 118 to automatically or semi-automatically control agricultural harvester 102 to follow pass 118. System 110 can also output an indication of pass 118 to an operator so the operator can navigate agricultural harvester 102 along pass 118. System 110 can also notify material transfer vehicle 104 where to wait for agricultural harvester 102 to return. Other control signals can be generated to analyze smaller tracts of land or other breakthrough passes in field 112 as well.

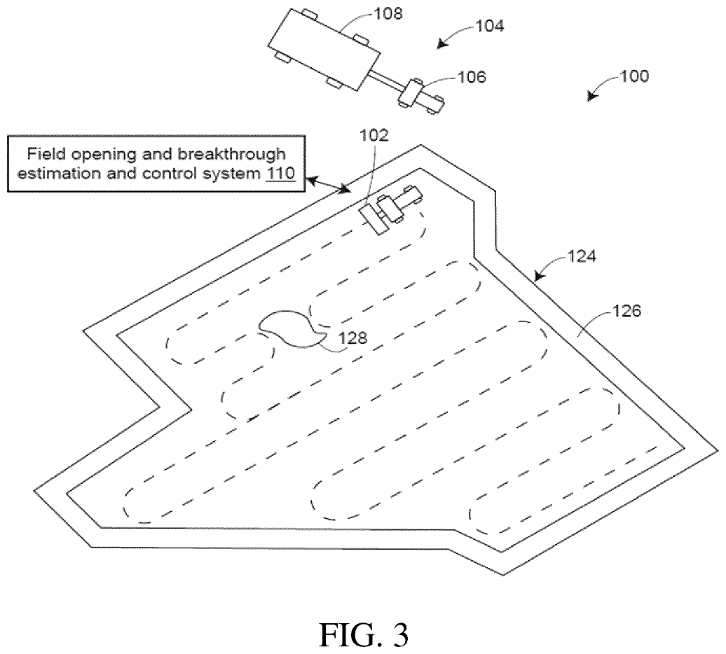

FIG. 3 shows agricultural harvester 102 in an irregularly shaped field 124. FIG. 3 shows that field 124 has already had the headlands 126 harvested. Also, field 124 is shown with an obstacle, such as a waterway or ditch 128. It can be very difficult for the operator of agricultural harvester 102 to determine, in such an irregularly shaped field 126, where to perform a breakthrough pass, and which passes agricultural harvester 102 will be able to complete without needing to unload. Thus, in the example shown in FIG. 3, field opening and breakthrough estimation and control system 110 obtains the characteristics of field 104 (such as boundary, shape, topography, dimensions etc.), as well as characteristics of machine 102 (such as the machine capacity, the dimensions of machine 102, etc.), and characteristics of the crop planted in field 124 (such as a yield map or estimated yield geographically referenced to locations in field 124, the variability in the yield across field 124 etc.), obstacles (such as waterway 128) in field 124 and the location of those obstacles, among other things. Based upon the information, system 110 can identify a breakthrough pass that agricultural harvester 102 can likely traverse without needing to unload. This greatly enhances the efficiency of the harvesting operation, and the operation of the path planning and navigation systems used to control agricultural harvester 102, and reduces unnecessary field compaction, among other things.

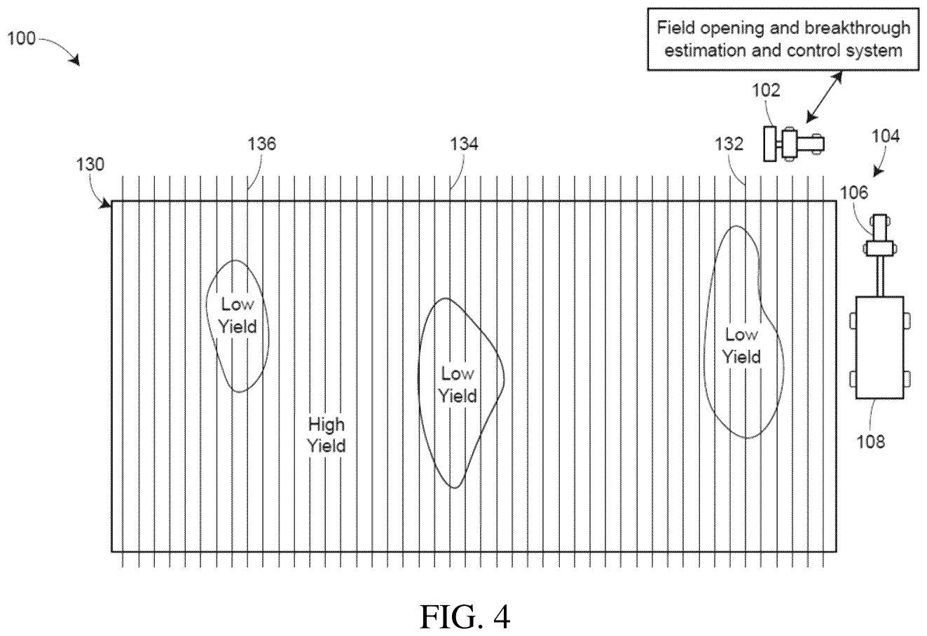

FIG. 4 is also a pictorial illustration of a field 130 which has a plurality of guidance lines that represent potential passes or tracks through field 130, superimposed thereon. The guidance lines can be generated by a path planning system used to generate a navigation path to navigate agricultural harvester 102. FIG. 4 also shows that field 130 has been divided into high yield areas and low yield areas. In the example shown in FIG. 4, field opening and breakthrough estimation and control system 110 obtains characteristics of field 130, characteristics of machine 102, and characteristics of the crop (including a yield map).

System 110 may determine that agricultural harvester 100 is incapable of performing a breakthrough pass in a high yield area of field 130 without needing to unload. Therefore, system 110 can analyze passes corresponding to the different guidance lines (or those corresponding to guidance lines that travel through low yield areas) to determine whether there is a pass that agricultural harvester 102 can traverse, as a breakthrough pass through field 130, where agricultural harvester 102 will likely not need to unload prior to completing the breakthrough pass. Thus, in one example, system 110 may identify the passes corresponding to guidance lines 132, 134, and 136 as passes that agricultural harvester 102 can make as a breakthrough pass without needing to unload. System 110 may provide an indication of one or more of passes 132, 134, and 136 to the operator of agricultural harvester 102 as one or more suggested passes. System 110 can also generate an output identifying passes 132, 134, and 136 to a path planning system or navigation system that is used to navigate agricultural harvester 102. System 110 can generate communication with instructions to material transfer vehicle 104. Because system 110 has access to the yield map or estimated yield in field 130, as well as access to the dimensions of machine 102, the distance across field 130, the capacity of the clean grain tank on agricultural harvester 102 (and the remaining capacity where the clean grain tank is partially filled), system 110 can identify passes 132, 134, and 136 as passes that agricultural harvester 102 can likely complete without needing to unload.

In Addition, system 110 can also perform headland analysis to determine whether agricultural harvester 102 can make one or more additional headland passes to reduce the length of the various passes through field 130. Reducing the length of the passes (by making additional headland passes) reduces the amount of material that will be harvested during the passes through field 130. Therefore, it may be more likely that agricultural harvester 102 will be able to complete a breakthrough pass without needing to unload. Other analysis and recommendations or control signals can be performed as well.

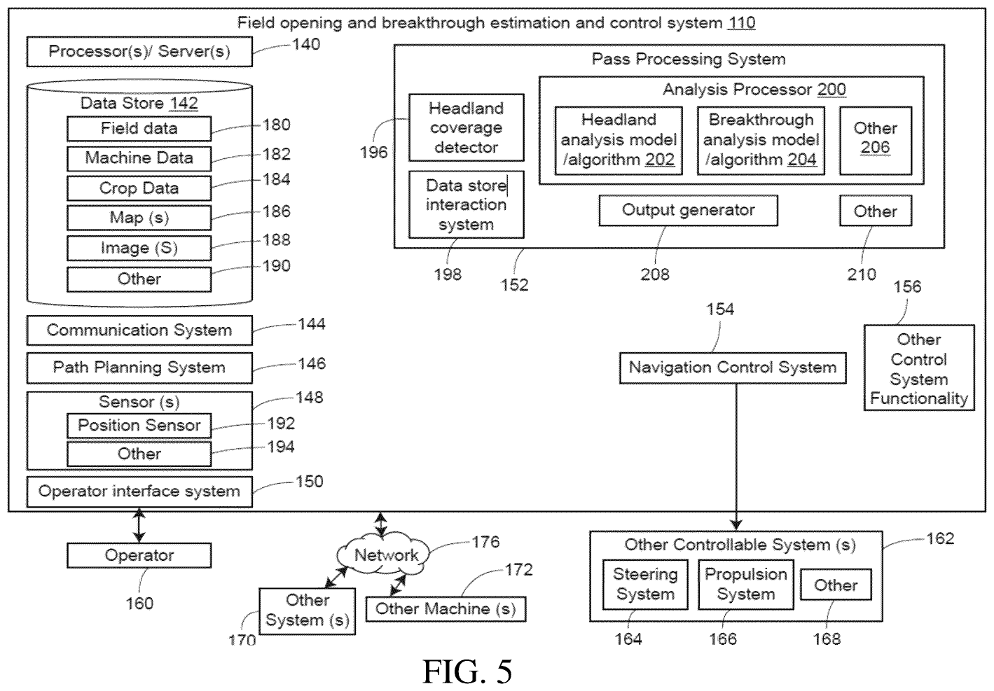

FIG. 5 is a block diagram showing one example of field opening and breakthrough estimation and control system 110 in more detail. FIG. 5 shows that an operator 160 of agricultural harvester 102 may interact with system 110. FIG. 5 also shows that system 110 can generate control signals to control other controllable systems 162 (such as the steering system 164, propulsion system 166, and other controllable subsystems 168) on agricultural harvester 102. Further, system 110 can communicate with other systems 170 and/or other machines 172 over a network 176. Other systems can include farm manager systems, vendor systems, or other systems. Other machines 172 can include material transfer vehicle 104, other agricultural harvesters, other tender vehicles, etc. Network 176 can be a wide area network, a local area network, a near field communication network, a cellular communication network, ethernet, a Wi-Fi or Bluetooth network, or any of a wide variety other networks or combinations of networks.

In the example shown in FIG. 5, system 110 includes processors or servers 140, data store 142, communication system 144, path planning system 146, sensors 148, operator interface system 150, pass processing system 152, navigation control system 154, and other control system functionality 156. It should be noted that system 110 can be deployed in agricultural harvester 102, in a remote server environment, on other machines or other systems, or system 110 can be distributed among various locations. System 110 is shown as a single system in FIG. 5 for the purposes of example only.

Before describing the overall operation of field opening and breakthrough estimation and control system 110, a description of some of the items in system 110, and their operation, will first be provided. Data store 142 can store field data 180, machine data 182, crop data 184, one or more maps 186, images 188, and/or other data 190. Field data 180 can include field boundaries, field dimensions, the locations of obstacles or features in the field, the locations of access points or approaches to the field, the shape of the field, among other data. Machine data 182 can include the make and model of the various machines (such as agricultural harvester 102, grain cart 108, tractor 106, etc.), the dimensions and capacities of the machines and/or other machine data. Crop data 184 can include crop type, crop hybrid or variety, estimated yield at different locations in the field, or other crop characteristics. Maps 186 can include yield maps of one or more different fields, NDVI maps, or other maps that can be used to identify crop characteristics such as yield, or field characteristics, such as the location of obstacles in the field, etc. Images 188 can include satellite images, other aerial images, or other images of the field being harvested, and other data.

Communication system 144 facilitates communication of the items in system 110 with one another and may facilitate communication over network 176. Therefore communication system 144 can include a controller area network (CAN) bus and bus controller, a cellular communication system, a wide or local area network communication system, or any of a wide variety of other communication systems or combinations of systems.

Operator interface system 150 includes operator interface mechanisms that can be used to receive inputs from operator 160 and generate outputs to operator 160. Thus, those mechanisms can include mechanical items such as a steering wheel, levers, pedals, joysticks, etc., as well as a display that can display information to operator 160 and that can receive inputs from operator 160 (such as by actuating an icon, link, button, etc.). The mechanisms can include other mechanisms for generating audio, visual, and/or haptic outputs to operator 160 and for receiving inputs from operator 160 and for generating an indication of those operator inputs to other elements of system 110.

Path planning system 146 illustratively generates a path or route for agricultural harvester 102 through the field. Path planning system 146 can use or generate guidance lines (such as those shown in FIG. 4) or generate a path in other ways. Path planning system 146 can generate an output indicative of a selected path to navigation control system 154. Navigation control system 154 can generate control signals to control other controllable systems 162 (such as steering system 164, propulsion system 166, etc.) to automatically or semi-automatically navigate harvester 102 along the path provided by path planning system 146. The navigation control system 154 can also control the operator interface system 150 to output the guidance lines to the operator, so the operator can perform navigation. In doing so, navigation control system 154 can obtain a sensor signal from sensors 148 (which may include a position sensor 192 and other sensors 194) to navigate agricultural harvester 102 along the path. The position sensor 192 can be a global navigation satellite system (GNSS) sensor, a cellular triangulation sensor, a dead reckoning system, or any of a wide variety of other position sensors that provide an output indicative of the position of sensor 192 in a global or local coordinate system.

It will be noted that path planning system 146 and navigation control system 154 can be any of a wide variety of different types of systems. Such systems can be based on the A-Star algorithm, the D-Star algorithm, the Dijkstra system, a genetic algorithm, or any of a wide variety of other algorithms or systems. The path planning system 146 and navigation control system 154 can incorporate inertial guidance systems, robotic mapping systems, satellite navigation systems, or any of a wide variety of other navigation systems.

Pass processing system 152 can include headland coverage detector 196, data store interaction system 198, analysis processor 200 (which includes headland analysis model/algorithm 202, breakthrough analysis model/algorithm 204, and other items 206), output generator 208, and other items 210. Headland coverage detector 196 detects whether the headlands or field opening pass has been completed in a field under analysis (e.g., a field that is being harvested or that is about to be harvested by agricultural harvester 102). In one example, headland coverage detector 196 can obtain access to or generate a map based upon the paths traveled by agricultural harvester 102 through the field under analysis and compare that to a map of the field to identify areas that have already been harvested. This will provide an indication as to whether the headland aeras have been harvested or a field opening pass has already been performed.

Data store interaction system 198 accesses information in data store 142. Analysis processor 200 can obtain the proposed path generated by path planning system 146 for agricultural harvester 102 and process that path to determine whether agricultural harvester 102 can complete that pass without unloading. Processor 200 can be a neural network, a machine learning system, a rules-based system, or another model or algorithm that is trained to indicate whether agricultural harvester 102 can likely complete a pass without unloading based upon the field data 180, machine data 182, crop data 184, maps 186, images 188, and/or other data 190.

For instance, headland analysis model/algorithm 202 may be trained to identify the headland areas of a particular field and access estimated yield data corresponding to the location of the headland or field opening pass to calculate the approximate volume of material that will be harvested during that pass. Model/algorithm 202 can then compare that volume to the available capacity in agricultural harvester 102 to generate an output indicating whether it is likely or unlikely that harvester 102 can complete the pass without unloading. In one example, model/algorithm 202 generates an output metric indicative of a likelihood or a probability that agricultural harvester 102 can complete the field opening or headland pass without unloading. In another example, model/algorithm 202 generates a binary metric output (e.g. an output indicating unloading is likely or unloading is unlikely) based on how likely or how probable it is that agricultural harvester 102 can complete the pass without unloading, and based on a confidence that model/algorithm 202 has in that particular likelihood or probability.

Breakthrough analysis model/algorithm 204 can obtain access to the guidance lines or proposed passes that path planning system 146 provides for the breakthrough pass through a field. Breakthrough analysis model/algorithm 204 can identify the probability or likelihood or other metric indicative of whether agricultural harvester 102 is likely to be able to complete the breakthrough pass without unloading. For instance, based upon the remaining capacity in the clean grain tank of agricultural harvester 102 and based upon the length and estimated yield of crop along a pass or guidance line being analyzed, model/algorithm 204 can determine whether agricultural harvester 102 can harvest the crop along the pass or guidance line under analysis without unloading material from its clean grain tank. The outputs or metrics generated by analysis processor 200 can be provided to output generator 208 which generates an output indicative of those indicators or metrics.

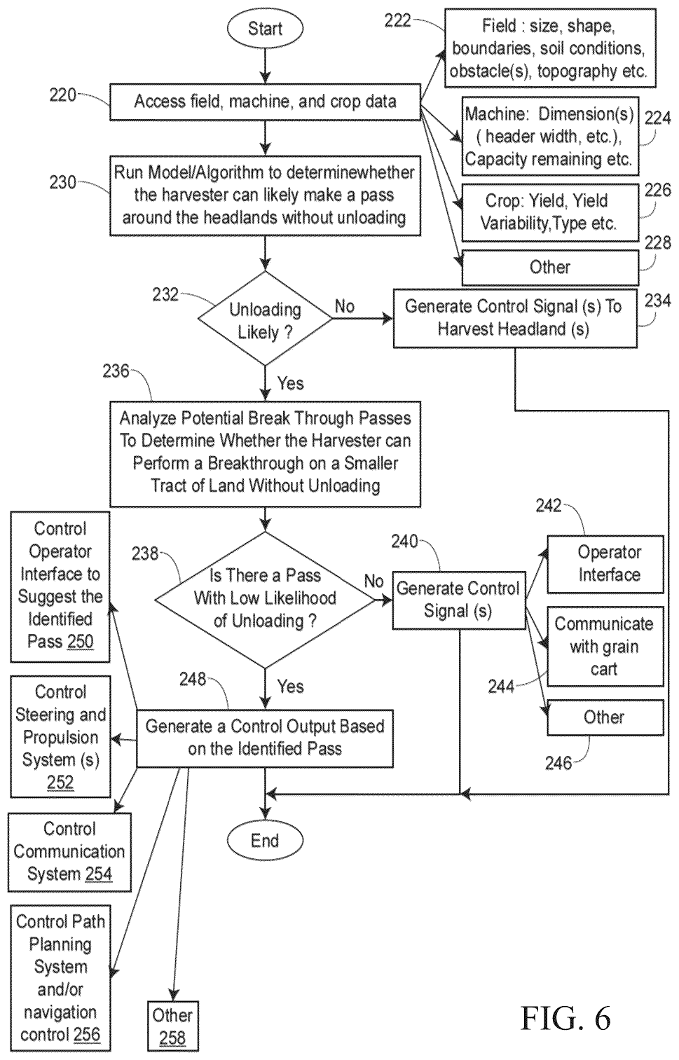

FIG. 6 is a flow diagram illustrating one example of the operation of agricultural system 100 (and field opening and breakthrough estimation and control system 110) in performing processing and control corresponding to a field opening or headland pass. It is first assumed that data store interaction system 198 accesses the field data 180, machine data 182, and crop data 184, as well as any other maps 186, images 188, or other data 190. Accessing the field, machine, and crop data is indicated by block 220 in the flow diagram of FIG. 6. In one example, the field data includes the field size, shape, boundaries, soil conditions, any obstacles in the field, the topography of the field, etc., as indicated by block 222. The machine data 182 can include machine dimensions (such as header width, clean grain tank capacity, etc.), the remaining capacity in the clean grain tank, the capacity of the grain cart 108, the size and other dimensions of material transfer vehicle 104, etc., as indicated by block 224 in the flow diagram of FIG. 6. The crop data 184 can include crop type, the estimated yield, the yield variability, the yield and yield variability mapped to geographical points in the field, as well as other crop information, as indicated by block 226. The other accessed information can include NDVI maps, yield maps, topographical maps, satellite images, unmanned aerial vehicle images, etc., as indicated by block 228. Based on the information retrieved, analysis processor 200 runs headland analysis model/algorithm 202 to determine whether the harvester can likely make a pass around the headlands (e.g., by circumventing the field) without unloading. Running the model/algorithm 202 and outputting a metric based on the accessed information is indicated by block 230 in the flow diagram of FIG. 6.

If it is unlikely that agricultural harvester 102 will need to unload prior to circumventing the field in a headland or field opening pass, as determined at block 232, then model/algorithm 202 generates an output metric indicative of this to output generator 208. Output generator 208 generates a control signal indicating that agricultural harvester 102 should proceed to harvest the headlands. Generating a control signal is indicated by block 234 in the flow diagram of FIG. 6. The control signals can include generating an output to navigation control system 154 and path planning system 146 so that path planning system 146 can generate a path or route for agricultural harvester 102 through the field, beginning with the headland pass, and so that navigation control system 154 can generate control signals to control steering system 164 and propulsion system 166 to automatically navigate agricultural harvester 102 around the headland pass. The control signals can include controlling communication system 144 to communicate with material transfer vehicle 104 indicating that material transfer vehicle 104 should wait until agricultural harvester 102 traverses the field. The control signals can control operator interface system 150 to generate an output for operator 160 indicating that agricultural harvester 102, suggesting the headland pass or field opening pass. The control signals can be control signals to communicate with other systems 170, or other machines 172, among other things.

If, at block 232, it is determined that agricultural harvester 102 will likely need to unload before circumventing the field in a headland pass, then breakthrough analysis model/algorithm 204 processes the accessed data to analyze other potential breakthrough passes to determine whether the agricultural harvester 102 can perform a breakthrough on a smaller tract of land without unloading. Performing such analysis is indicated by block 236 in the flow diagram of FIG. 6. One example of such processing is described above with respect to FIG. 2.

Breakthrough analysis model/algorithm 204 can identify the remaining capacity in the clean grain tank of agricultural harvester 102 (such as by accessing a sensor signal on agricultural harvester 102 that senses the level of crop material in the clean grain tank, or that tracks the amount of crop material that is processed and stored in the clean grain tank since a last unloading operation, or in other ways), as well as the estimated yield in performing a breakthrough pass 118 on a smaller tract of land 120 to determine whether agricultural harvester 102 can make such a pass without needing to unload. Of course, a wide variety of other information can be analyzed as well.

If such a pass cannot be identified, as determined at block 238, then model/algorithm 204 generates an output metric indicative of this to output generator 208 which generates a control signal based upon that output metric, as indicated by block 240. Such control signals can be used to control operator interface system 150 to generate an output for operator 160 indicating that the agricultural harvester 102 will likely need to unload during the field opening or headland pass, as indicated by block 242 in the flow diagram of FIG. 6. The control signals can be to control communication system 144 to communicate with material transfer vehicle 104 indicating that the material transfer vehicle should follow agricultural harvester 102 on the breakthrough or headland pass, as indicated by block 244 in the flow diagram of FIG. 6. The control signal can be any of a wide variety of other control signals, as indicated by block 246.

If, at block 238, it is determined that breakthrough analysis model/algorithm 204 identifies a pass where agricultural harvester 102 is unlikely to need to unload prior to completing that breakthrough pass, then model/algorithm 204 generates an output identifying such a pass to output generator 208, which generates a control signal or a control output based upon the identified pass. Generating such a control output is indicated by block 248 in the flow diagram of FIG. 6. The control output can again include such things as controlling the operator interface system 150 to suggest the identified pass to operator 160 of agricultural harvester 102. The identified pass may be displayed to operator 160 on a map display, on a heads-up display, or in other ways. Controlling the operator interface system 150 to identify the suggested pass to operator 160 is indicated by block 250 in the flow diagram of FIG. 6.

The control output may be a control signal provided to navigation control system 154 to control steering system 164 and propulsion system 166 so that agricultural harvester 102 automatically follows the suggested pass, as indicated by block 252 in the flow diagram of FIG. 6. The control output may be to control communication system 144 to communicate with other systems 170, and/or other machines 172 (such as material transfer vehicle 104 or other tender vehicles or harvesters). Such communication may be to indicate, for example, to material transfer vehicle 104 where the breakthrough pass 118 is located, where vehicle 104 should wait, etc. The control signals can also be used to control communication system 144 to communicate with other machines 172, other systems, etc., as indicated by block 254 in the flow diagram of FIG. 6.

The control signals can provide an output to path planning system 146 identifying the pass with a low likelihood that agricultural harvester 102 will need to unload so that path planning system 146 can generate a new route for agricultural harvester 102 and provide that route to navigation control system 154. The control signal can be an output directly to navigation control system 154 so that navigation control system 154 can control the other controllable systems 162 to navigate agricultural harvester 102 along the identified pass. Providing a control output to path planning system 146 and/or navigation control system 154 is indicated by block 256 in the flow diagram of FIG. 6. The control output can take any of a wide variety of other forms, to control other items, as well, as indicated by block 258 in the flow diagram of FIG. 6.

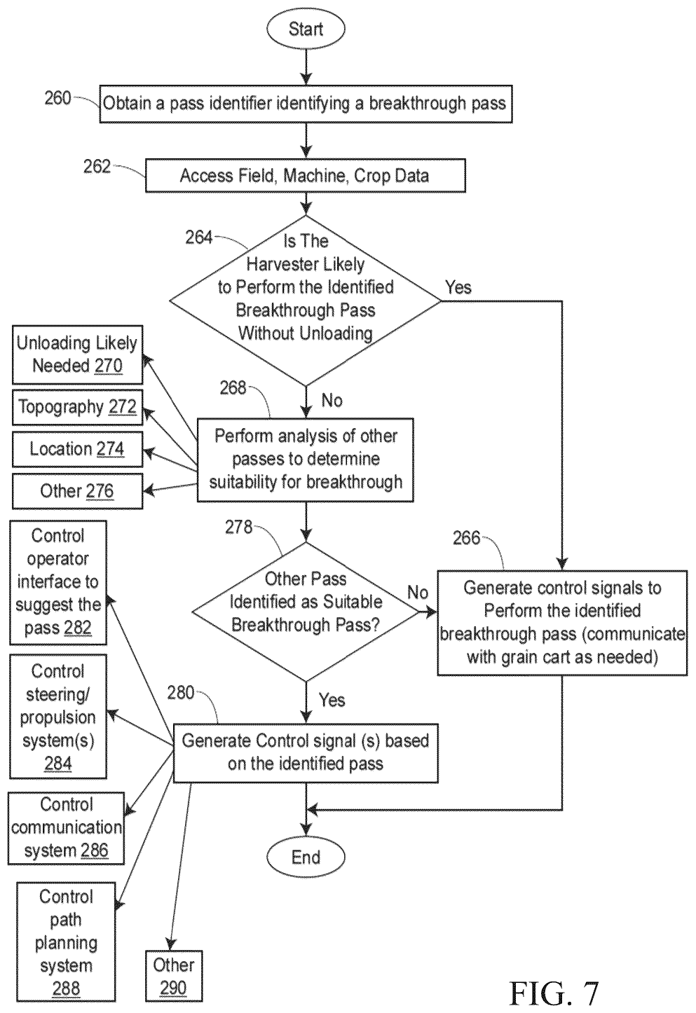

FIG. 7 is a flow diagram illustrating one example of the operation of agricultural system 100 and field opening and breakthrough estimation and control system 110 in identifying a breakthrough pass, after the headlands have been harvested, where agricultural harvester 102 can likely complete the breakthrough pass without needing to unload. It is first assumed that path planning system 146 or another system or operator provides a pass identifier identifying a breakthrough pass for harvester 102. Receiving a pass identifier is indicated by block 260 in the flow diagram of FIG. 7. Pass processing system 152 then accesses field data 180, machine data 182, and crop data 184 (among other possible data) as indicated by block 262 in the flow diagram of FIG. 7. In one example, such data is accessed by data store interaction system 198 interacting with data store 142 to obtain that data. In another example, some or all of the data can be provided by an operator 160 or another system 170, or in other ways.

Breakthrough pass analysis model/algorithm 264 then analyzes that data to determine whether the harvester is likely to perform the identified breakthrough pass (received from path planning system 146 or another system) without unloading, as indicated by block 264. For instance, as discussed elsewhere herein, breakthrough analysis model/algorithm 204 can be a neural network, a machine learning system, a rules-based system, or any of a wide variety of other models or algorithms that are configured (e.g., trained) to analyze the estimated or predicted yield in the areas corresponding to the identified breakthrough pass as well as the remaining capacity in agricultural harvester 102 and/or other information, to determine whether agricultural harvester 102 is likely to be able to complete the breakthrough without unloading. If so, then model/algorithm 204 generates an output metric having a metric value indicative of this to output generator 208. Output generator 208 then generates control signals to perform the identified breakthrough pass, as indicated by block 266 in the flow diagram of FIG. 7.

For instance, the control signals can be output to path planning system 146 and/or navigation control system 154 to indicate that the identified breakthrough pass should be followed. The control signals can be provided to operator interface system 150 to indicate to operator 160 that the identified breakthrough pass should be followed. The control signals can be used to control communication system 144 to communicate with other systems 170 and/or other machines 172 (such as material transfer vehicle 104) indicating that agricultural harvester 102 will likely be able to complete the breakthrough pass without needing to unload. Other control signals can be generated to perform other operations as well.

If, at block 264, breakthrough analysis model/algorithm 204 generates an output metric having a metric value indicating that it is unlikely that agricultural harvester 102 will be able to complete the identified breakthrough without unloading, then breakthrough analysis model/algorithm 204 identifies and analyzes other possible passes (such as the passes corresponding to the guidance lines illustrated in field 130 shown in FIG. 4) to determine whether any other potential passes are suitable for breakthrough (e.g., passes that are in relatively close proximity to agricultural harvester 102 and passes which the agricultural harvester 102 is likely to be able to complete without unloading). For instance, model/algorithm 204 can analyze the length of each pass, the estimated yield corresponding to each pass, the width of the header on agricultural harvester 102, the remaining capacity in the clean grain tank of harvester 102, the topography of the pass, etc. Analyzing other passes to determine their suitability for a breakthrough pass is indicated by block 268 in the flow diagram of FIG. 7. Performing an analysis to determine whether agricultural harvester 102 will likely need to unload before completing a pass under analysis is indicated by block 270.

Analyzing the topography of the pass under analysis is indicated by block 272. For instance, the topography can be considered in a variety of different ways. By way of example, if the clean grain tank will likely be nearly full in an area of the pass under analysis where the topography is sloping sideways or sloping in another direction (so that grain may spill out of the clean grain tank), then model/algorithm 204 may determine that, with that topography, the pass under analysis is not suitable for a breakthrough pass. Further, if the pass under analysis is undulating, this can increase the linear distance that agricultural harvester 102 travels to complete that pass, which may mean that the remaining capacity in the clean grain tank of agricultural harvester 102 is insufficient to complete the pass. The topology can be considered in other ways as well.

Determining whether the pass under analysis is suitable for breakthrough based upon its location is indicated by block 274 in the flow diagram of FIG. 7. The location may be considered by identifying how close the pass under analysis is relative to the position of agricultural harvester 102. If there is another suitable breakthrough pass that is more closely proximate agricultural harvester 102, then the pass under analysis may be considered unsuitable. Also, if the pass under analysis is a relatively great distance (e.g., further than a threshold distance) from a current position of agricultural harvester 102, this may indicate that the efficiencies introduced by having agricultural harvester 102 follow that pass outweigh the efficiencies gained by selecting a pass that agricultural harvester 102 can complete without unloading. The location of the pass under analysis may be considered in other ways as well.

Model/algorithm 204 can consider a wide variety of other data and perform other analyses to determine the suitability of a particular pass as a breakthrough pass as indicated by block 276 in the flow diagram of FIG. 7.

If no other passes analyzed by breakthrough analysis model/algorithm 204 are identified as suitable breakthrough passes, as determined at block 278 in the flow diagram of FIG. 7, then processing again continues at block 266 where control signals are generated to perform the originally identified breakthrough pass. However, if, at block 278, it is determined that another pass has been analyzed and determined to be suitable as a breakthrough pass, then model/algorithm generates an output metric having a value identifying that other pass to output generator 208, and output generator 208 generates a control signal based upon the identified pass. Generating such a control signal is indicated by block 280 in the flow diagram of FIG. 7. The control signals can be used to control operator interface system 150 to suggest the identified pass as a breakthrough pass, as indicated by block 282.

The control signals can be used by output generator 208 and/or navigation control system 154 to control the steering system 164 and propulsion system 166 to automatically or semi-automatically navigate agricultural harvester 102 along the identified breakthrough pass, as indicated by block 284 in the flow diagram of FIG. 7. The control signal can be used to control communication system 144 to communicate with other systems 170 or other machines 172 (such as material transfer vehicle 104 or other machines) as indicated by block 286 in the flow diagram of FIG. 7. The control signals can be provided to path planning system 146 so that path planning system 146 can generate a route or path for agricultural harvester 102 through the field, using the identified pass as the breakthrough pass. Providing a control output to path planning system 146 is indicated by block 288 in the flow diagram of FIG. 7. The control signals can take any of a wide variety of other forms to perform other control operations as well, as indicated by block 290.

It can thus be seen that the present description describes a system that processes different passes through a field to increase the accuracy and efficiency in the navigation and path planning systems in performing path planning and navigation of an agricultural harvester 102 in opening a field and/or performing a breakthrough pass. By performing such analysis, the present system reduces field damage by reducing unneeded compaction on the field, and increases efficiency by reducing fuel consumption of material transfer vehicle 104, and by reducing the need for agricultural harvester 102 to remain idle in the field waiting for a material transfer vehicle 104.

The present discussion has mentioned processors and servers. In one example, the processors and servers include computer processors with associated memory and timing circuitry, not separately shown. The processors or servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, detectors, models/algorithms, and/or logic. It will be appreciated that such systems, components, generators, detectors, models/algorithms, and/or logic can be comprised of hardware items (such as processors and associated memory, or other processing components, some of which are described below) that perform the functions associated with those systems, components, generators, detectors, models/algorithms, and/or logic. In addition, the systems, components, generators, detectors, models/algorithms, and/or logic can be comprised of software that is loaded into a memory and is subsequently executed by a processor or server, or other computing component, as described below. The systems, components, generators, detectors, models/algorithms, and/or logic can also be comprised of different combinations of hardware, software, firmware, etc., some examples of which are described below. These are only some examples of different structures that can be used to form the systems, components, generators, detectors, models/algorithms, and/or logic described above. Other structures can be used as well.

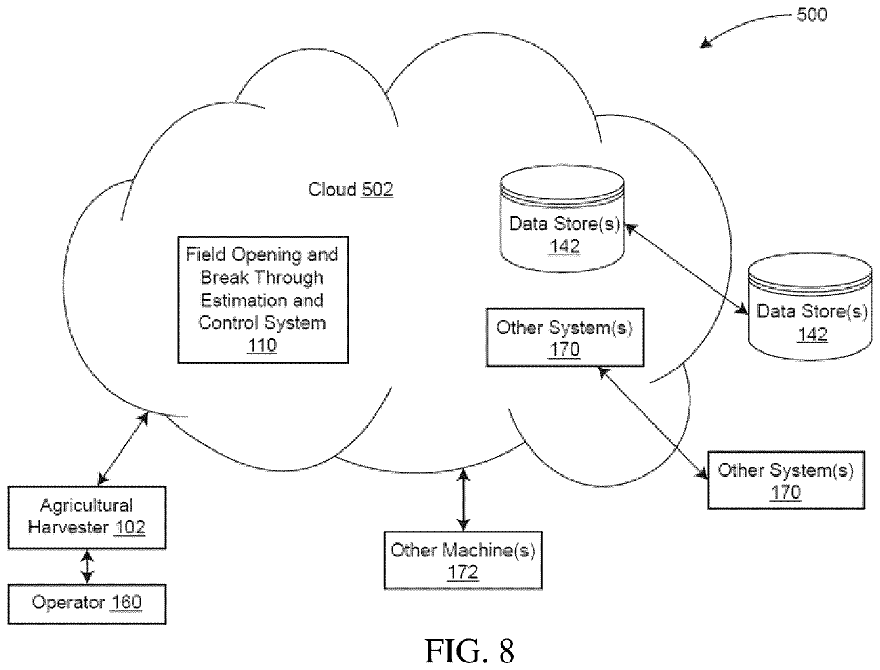

FIG. 8 is a block diagram of harvester 102, shown in other FIGS., except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 8, some items are similar to those shown in previous FIGS. and they are similarly numbered. FIG. 8 specifically shows that system 110, other systems 170, and data store 142 can be located at a remote server location 502. Therefore, harvester 102 accesses those systems through remote server location 502.

FIG. 8 also depicts another example of a remote server architecture. FIG. 8 shows that it is also contemplated that some elements of previous FIGS are disposed at remote server location 502 while others are not. By way of example, data store 142 or other systems 170 can be disposed at a location separate from location 502, and accessed through the remote server at location 502. Regardless of where the items are located, the items can be accessed directly by harvester 102, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

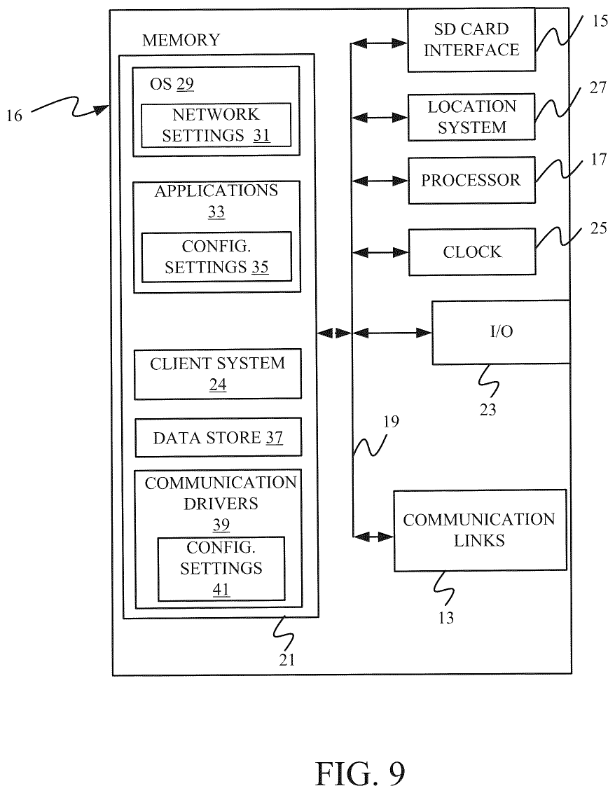

FIG. 9 is a simplified block diagram of one illustrative example of a handheld or mobile computing device that can be used as a user's or client's hand held device 16, in which the present system (or parts of it) can be deployed. For instance, a mobile device can be deployed in the operator compartment of harvester 102 for use in generating, processing, or displaying pass data. FIGS. 9-11 are examples of handheld or mobile devices.

FIG. 9 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. Location system 27 can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

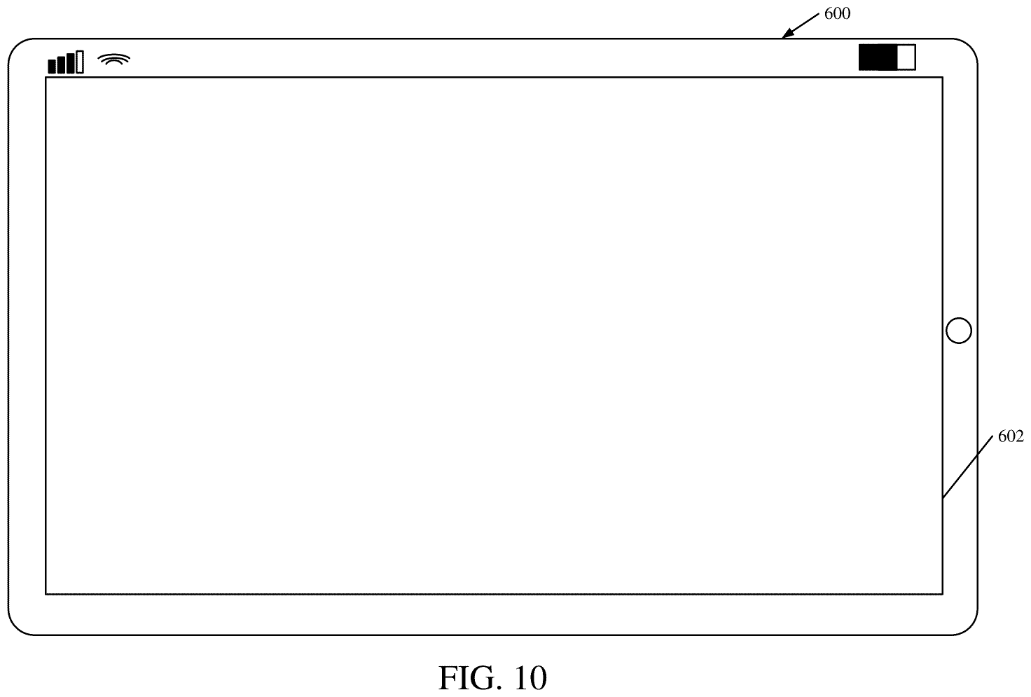

FIG. 10 shows one example in which device 16 is a tablet computer 600. In FIG. 10, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

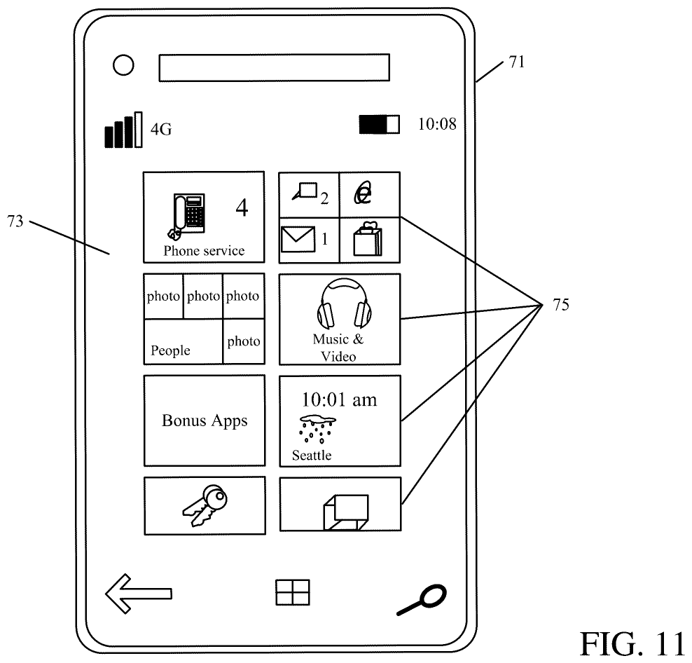

FIG. 11 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

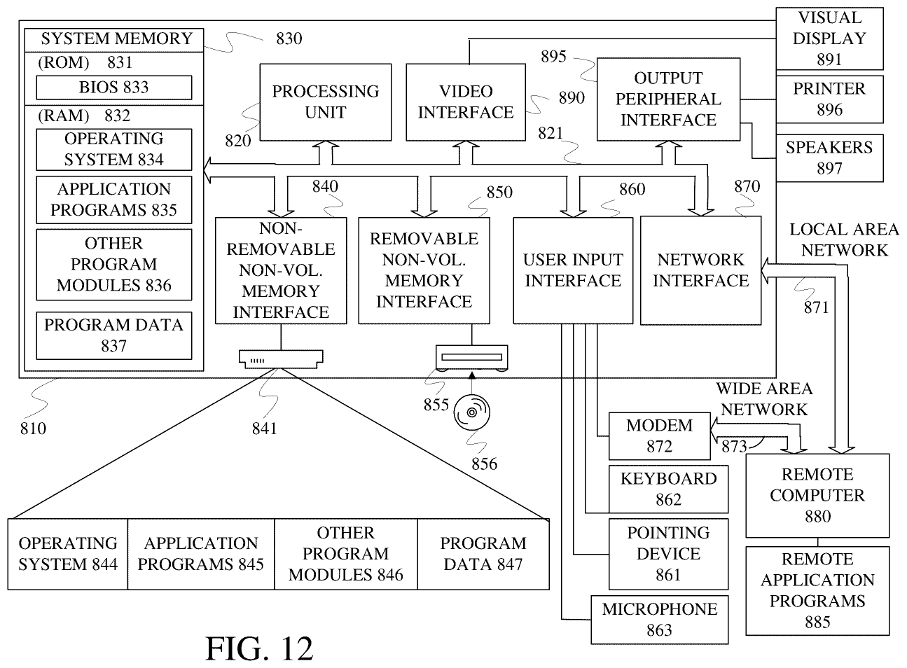

FIG. 12 is one example of a computing environment in which elements of previous FIGS., or parts of it, (for example) can be deployed. With reference to FIG. 12, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 12 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
obtaining a first pass indicator indicative of a first breakthrough pass in a field for an agricultural harvester;
generating a first metric value indicative of whether the agricultural harvester can complete the first breakthrough pass without unloading an agricultural commodity from on the agricultural harvester; and
generating a control signal based on the first metric value.

2. The computer implemented method of claim 1 wherein obtaining a first pass indicator comprises:
obtaining a geographic location of the first breakthrough pass.

3. The computer implemented method of claim 2 wherein generating a first metric value comprises:
accessing a georeferenced yield estimate corresponding to the geographic location of the first breakthrough pass.

4. The computer implemented method of claim 3 wherein generating a first metric value comprises:
calculating an estimated yield corresponding to the first breakthrough pass;
identifying a remaining capacity of a clean grain tank on the agricultural harvester;
comparing the estimated yield to the remaining capacity of the clean grain tank on the agricultural harvester to generate a comparison result; and
generating the first metric value based on the comparison result.

5. The computer implemented method of claim 1 and further comprising:
if the first metric value indicates that the agricultural harvester will not be likely to complete the first breakthrough pass without unloading a clean grain tank on the agricultural harvester, then obtaining a second pass indicator indicative of a second breakthrough pass in the field;
generating a second metric value indicative of whether the agricultural harvester can complete the second breakthrough pass without unloading the clean grain tank on the agricultural harvester; and
generating the control signal based on the second metric value.

6. The computer implemented method of claim 5 wherein, if the second metric value indicates that the agricultural harvester can likely complete the second breakthrough pass without unloading the clean grain tank on the agricultural harvester, then generating the control signal comprises:
generating an operator interface control signal to control an operator interface mechanism to identify the second breakthrough pass.

7. The computer implemented method of claim 5 wherein, if the second metric value indicates that the agricultural harvester can likely complete the second breakthrough pass without unloading the clean grain tank on the agricultural harvester, then generating the control signal comprises:
generating a path planning system control signal to control a path planning system to generate a route for the agricultural harvester using the second breakthrough pass.

8. The computer implemented method of claim 5 wherein, if the second metric value indicates that the agricultural harvester can likely complete the second breakthrough pass without unloading the clean grain tank on the agricultural harvester, then generating the control signal comprises:
generating a navigation control signal to control a navigation control system to control a steering system to navigate the agricultural harvester along the second breakthrough pass.

9. The computer implemented method of claim 5 wherein, if the second metric value indicates that the agricultural harvester can likely complete the second breakthrough pass without unloading the clean grain tank on the agricultural harvester, then generating the control signal comprises:
generating a communication system control signal to control a communication system to communicate a message to a material transfer vehicle indicating that the agricultural harvester will likely complete the second breakthrough pass without unloading the clean grain tank.

10. The computer implemented method of claim 1 wherein generating a metric value comprises:
obtaining machine characteristic data indicative of a characteristic of the agricultural harvester, field characteristic data indicative of a characteristic of the field, and crop characteristic data indicative of a characteristic of a crop; and
running a model to obtain the metric value based on the machine characteristic data, the field characteristic data and the crop characteristic data.

11. The computer implemented method of claim 1 and further comprising:
if the first metric value indicates that the agricultural harvester will not likely complete the first breakthrough pass without unloading a clean grain tank on the agricultural harvester, then performing a headland analysis to determine whether performing an additional headland pass to reduce a length of the first breakthrough pass changes the first metric value to indicate that the agricultural harvester will likely complete the first breakthrough pass without unloading the clean grain tank.

12. A computer implemented method, comprising:
computing a metric indicative of whether an agricultural harvester has capacity to complete a first field opening pass in a field without unloading harvested material from the agricultural harvester;
if the metric indicates that the agricultural harvester has capacity to complete the first field opening pass in the field without unloading harvested material from the agricultural harvester, generating a first control signal to control a controllable system based on the metric; and
if the metric indicates that the agricultural harvester has insufficient capacity to complete the first field opening pass in the field without unloading harvested material from the agricultural harvester, generating a second control signal to control a controllable system based on the metric.

13. The computer implemented method of claim 12 wherein computing a metric comprises:
accessing a set of machine data indicative of a remaining capacity of a clean grain tank on the agricultural harvester;
accessing yield data indicative of an estimated crop yield corresponding to the first field opening pass;
comparing an amount of crop harvested from the first field opening pass, based on the yield data, to the remaining capacity of the clean grain tank on the agricultural harvester; and
generating, as the metric, a comparison result.

14. The computer implemented method of claim 13 wherein generating a second control signal comprises:
identifying an alternate field opening pass that is different than the first field opening pass; and
computing the metric indicative of whether the agricultural harvester has capacity to complete the alternate field opening pass in the field without unloading harvested material from the agricultural harvester.

15. The computer implemented method of claim 14 wherein identifying an alternate field opening pass comprises:
identifying, as the alternate field opening pass, a field opening pass that corresponds to a lower estimated crop yield than the first field opening pass.

16. The computer implemented method of claim 14 wherein identifying an alternate field opening pass comprises:
obtaining a first breakthrough pass indicator indicative of a first breakthrough pass in the field, wherein computing the metric comprises computing the metric based on the estimated crop yield corresponding to the first breakthrough pass.

17. The computer implemented method of claim 12 wherein computing a metric comprises:
accessing machine characteristic data indicative of a characteristic of the agricultural harvester;
accessing field characteristic data indicative of a characteristic of the field;
accessing crop characteristic data indicative of a characteristic of a crop planted in the field; and
running a machine learning model based on the machine characteristic data, the field characteristic data, and the crop characteristic data to obtain the metric.

18. An agricultural system, comprising:
an agricultural harvester having a clean grain tank;
a path planning system configured to generate a pass indicator indicative of a breakthrough pass in a field for the agricultural harvester;
a processing system configured to generate a metric value indicative of whether the agricultural harvester can complete the breakthrough pass without unloading the clean grain tank on the agricultural harvester; and
an output generator configured to generate a control signal based on the metric value.

19. The agricultural system of claim 18 wherein the path planning system is configured to generate the pass indicator with a geographic location of the breakthrough pass.

20. The agricultural system of claim 19 wherein the processing system is configured to access a georeferenced yield estimate corresponding to the geographic location of the breakthrough pass and generate the metric value based on the georeferenced yield estimate.
